(19) United States
(12) Patent Application Publication
(10) Pub. No.: US 2004/0004203 A1
(43) Pub. Date: Jan. 8, 2004

(54) Valve for making fine adjustments to a flow of fluid

(76) Inventor: Paul K. Smith, Kirkland, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/613,884

(22) Filed: Jul. 3, 2003

Related U.S. Application Data
(60) Provisional application No. 60/393,372, filed on Jul. 3, 2002.

(51) Int. Cl. F16K 7/16

(52) U.S. Cl. 251/205; 251/126

(57) ABSTRACT

The invention provides a valve that one may use to finely adjust the amount of fluid that flows to a device such as a portable gas burner. The valve includes a receiver through which fluid flows when the valve is open, a metering groove operable to form a metering passage in the receiver to limit the flow of fluid through the receiver, and a stem positionable relative to the receiver to form the metering passage from different portions of the metering groove to adjust the amount of fluid that may flow through the receiver. The metering groove includes a groove axis that extends the length of the metering groove and cross-sectional areas oriented perpendicular to the groove axis that differ according to their location along the axis. The metering passage is formed from all or a portion of the metering groove, and limits the flow of fluid through the receiver with the smallest cross-sectional area of the metering groove portion that forms the metering passage. To adjust the flow of fluid through the receiver, one moves the stem relative to the receiver to change the portion of the metering groove that forms the metering passage, and thus, change the smallest cross-sectional area of the metering groove that is included in the metering passage. Thus, the valve can finely adjust the amount of fluid that flows through the valve.

This application claims priority from commonly owned U.S. Provisional Patent Application 60/393,372, filed Jul. 3, 2002 and presently pending, titled NEEDLE VALVE, which is hereby incorporated by reference in its entirety.

### BACKGROUND

The ability to make fine adjustments to a flow of a fluid may be desirable in many different applications and systems. For example, a person cooking a meat stew on a portable gas stove while camping may want to set the gas stove to provide medium-low heat to cook the stew within a reasonable time without having to constantly stir the stew to prevent burning it. Setting the gas burner to provide a desired amount heat typically involves operating a valve to adjust the amount of fuel that may flow to the burner.

For example, most gas burners use a needle valve like the one shown in FIG. 1 to control the flow of fuel to a stove. As shown in FIG.1, the needle valve 10 includes an inlet 12 to receive fuel from a storage container (not shown), an outlet 14 to provide fuel to the stove (not shown) and a needle 16 to adjust the amount of fuel that flows through the outlet 14. The needle 16 includes a tip 18 that is contoured to match the valve seat 20 of the needle valve 10, and threads 22 that correspond with threads 24 of the needle valve's housing 25 to move the tip 18 relative to the valve seat 20 along the axis 26. When the tip 18 contacts the valve seat 20 the needle valve 10 is closed and fuel is not supposed to flow through the outlet 14. To open the needle valve 10, one turns the handle 27 to move the tip 18 away from the valve seat 20 and allow fuel to flow through the passage 28 and the outlet 14. Because the amount of fuel that flows through the outlet 14 depends on the cross-sectional area of the passage 28, one adjusts the amount of fuel that flows through the outlet 14 by increasing or decreasing the distance between the tip 18 and the valve seat 20.

Unfortunately, the needle valve 10 fails to allow one to finely adjust the amount of fuel that may flow through the outlet 14. Because the amount of fuel that flows through the outlet 14 depends on the distance between the valve seat 20 and the tip 18, the rate of adjustment approximates the pitch of the threads 22 and 24. To provide fine adjustment in the amount of fuel that flows through the needle valve 10, the pitch of the threads 22 and 24 would have to be so small that the housing 25 and needle 16 would be expensive to manufacture and would not be durable, particularly if the housing 25 is made of material with a material.

One possible solution is to decrease the angle between the axis 26 and the surfaces of the valve seat 20 and tip 18 to decrease the distance that the tip 18 travels away from the valve seat 20 after one turn of the needle 16. But, by decreasing the angle between the axis 26 and the surfaces of the valve seat 20 and tip 18, the range of adjustment in the amount of fuel that flows through the valve 10 decreases after multiple uses, and thus, the rate of adjustment also decreases. For example, when the valve 10 is closed, the tip 18 exerts pressure on the valve seat 20 in a direction away from the axis 26. In a low elastic modulus material, this expands the valve seat 20 causing the diameter of the valve seat 20 to increase. When the valve 10 is then opened, the valve seat 20 slowly contracts back to its designed configuration. This contraction may take several minutes and if the valve is opened a small amount the contraction may eventually close the valve 10.

### SUMMARY OF THE INVENTION

The invention provides a valve that one may use to finely adjust the amount of fluid (liquid or gas) that flows to a device such as a portable gas burner. The valve comprises a receiver through which fluid flows when the valve is open, a metering groove operable to form a metering passage to limit the flow of fluid through the receiver, and a stem positionable relative to the receiver to form the metering passage from different portions of the metering groove to adjust the amount of fluid that may flow through the receiver. The metering groove includes a groove axis that extends the length of the metering groove and cross-sectional areas oriented perpendicular to the groove axis that differ according to their location along the axis. The metering passage is formed from all or a portion of the metering groove, and limits the flow of fluid through the receiver with the smallest cross-sectional area of the metering groove portion that forms the metering passage. To adjust the flow of fluid through the receiver, one moves the stem relative to the receiver to change the portion of the metering groove that forms the metering passage, and thus, change the smallest cross-sectional area of the metering groove that is included in the metering passage. Thus, the valve can finely adjust the amount of fluid that flows through the valve.

In addition to finely adjusting the amount of fluid that flows through the valve, one may use the valve to coarsely adjust the amount of fluid that flows to a device. For example, when the valve is opened and the stem is positioned relative to the receiver such that a metering passage is not formed, the valve may function similar to the conventional valve shown in FIG. 1. More specifically, during coarse adjustment of the valve, the distance between a distal end of the stem and the receiver determines the amount of fluid that flows through the valve. Thus, one may use the valve to finely and coarsely adjust the amount of fluid that flows to a device as desired. Furthermore, when the valve is opened, the positioning of the stem's distal end out of the hole in the receiver allows particles to be cleared from the metering groove.

In one embodiment, the stem includes the metering groove located on a cylindrical tip, and the receiver includes a wall defining a cylindrical hole sized to receive the tip to form the metering passage. The metering groove has cross-sectional areas shaped like a “U” that differ along the groove axis in the distance between the crest and root of the “U”. When the tip of the stem is inserted into the hole of the receiver, all or a substantial portion of the fluid that flows through the receiver flows through the metering passage. Then, as one moves the tip further into or out of the hole, one decreases or increases, respectively, the flow of fluid through the receiver.

### BRIEF DESCRIPTION OF THE FIGURES

FIG. 1 is a cross-sectional view of a conventional needle valve.

FIG. 2 is an exploded, perspective view of a system that incorporates a valve according to an embodiment of the invention.

FIG. 3 is a cross-sectional view of a portion of the valve in FIG. 2 showing the valve in an open position.

FIG. 4 is a cross-sectional view of a portion of the valve in FIG. 2 showing the valve in a different, open position that allows more fluid to flow.

FIG. 5 is a cross-sectional view of a tip of the stem incorporated in the valve in FIG. 2 according to an embodiment of the invention.

FIG. 6 is a cross-sectional view of a portion of a valve according to another embodiment of the invention.

FIG. 7 is a graph showing the difference between the sensitivity in the adjustment of the amount of fluid flowing through a conventional needle valve and the valve in FIGS. 2-5.

FIG. 8 is another graph showing the difference between the sensitivity in the adjustment of the amount of fluid flowing through a conventional needle valve and the valve in FIGS. 2-5.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

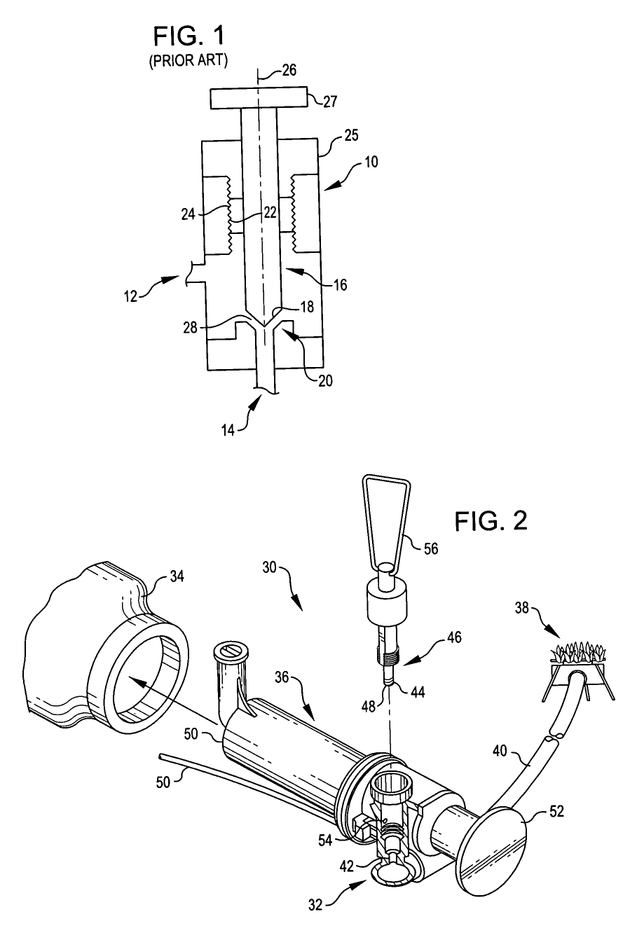

FIG. 2 is an exploded, perspective view of a system 30 that incorporates a valve 32 according to an embodiment of the invention. The system 30 may be any system that includes a valve for adjusting the flow of a fluid, which may be a liquid such as water or fuel, or may be a gas such air or vaporized fuel, from one location to another. For example, the system 30 shown in FIG. 2 is a portable system for generating heat. The system 30 includes a fuel bottle 34 to store fuel (not shown), a pump 36 to pressurize the fuel bottle 34, a burner 38 to burn the fuel and generate heat, and the valve 32 to adjust the amount of fuel delivered to the burner 38. The system 30 also includes a conduit 40 that couples the valve 32 with the burner 38 to supply the burner 38 with the fuel that flows through the valve 32.

With the valve 32, one can finely adjust the amount of fuel the burner 38 receives and thus finely adjust the amount of heat the burner 38 generates. Consequently, one may use the system 30 to cook a meat stew with medium-low heat within a reasonable time without having to constantly stir the stew to prevent burning it.

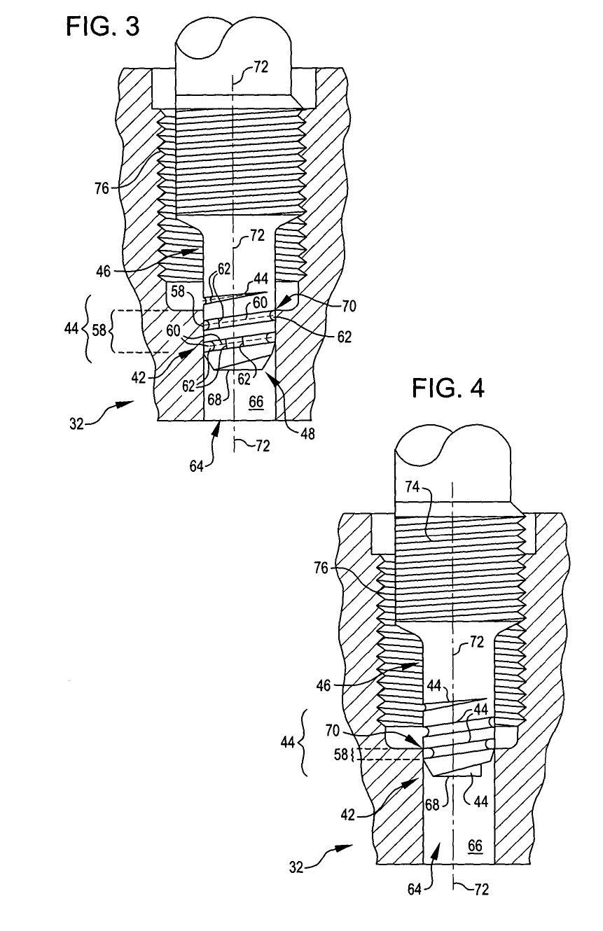

Still referring to FIG. 2, the valve 32 includes a receiver 42 through which fuel flows when the valve 32 is open, a metering groove 44 (discussed in greater detail in conjunction with FIGS. 3-5) to form a metering passage (not shown but discussed in greater detail in conjunction with FIGS. 3 and 4) in the receiver 42 to limit the flow of fuel through the receiver 42. The valve 32 also includes a stem 46 that one may position relative to the receiver 42 to adjust the amount of fuel that flows through the receiver 42 (also discussed in greater detail in conjunction with FIGS. 3-5). In one embodiment, the stem 46 includes the metering groove 44 located on a tip 48 that is inserted into the receiver 42 to form the metering passage of the valve 32. In other embodiments, the receiver 42 may include the metering groove 44 as discussed below, or both the receiver 42 and the stem 46 may include a metering groove.

In operation, one first inserts a portion 50 of the pump 36 into the bottle 34 while maintaining the valve 32 outside the bottle 34. Next, one pressurizes the inside of the bottle 34 by moving the pump handle 52 relative to the portion 50 of the pump 36 to urge fuel inside the bottle 34 into the valve 32 through the inlet 54. Then, if the valve 32 is open, fuel flows through the metering passage formed in the receiver 42 and into the conduit 40. In one embodiment, one turns the stem 46 relative to the receiver 42 with the handle 56 to position the tip 48 in the receiver 42 to adjust the flow of fuel through the receiver 42.

FIGS. 3 and 4 are similar cross-sectional views of a portion of the valve 32 in FIG. 2. FIG. 3 shows the valve 32 open to permit an amount of fluid to flow through the valve 32, and FIG. 4 shows the valve 32 open to permit a larger amount of fluid to flow through the valve 32.

Referring to FIGS. 3 and 4, the stem 46 is positioned relative to the receiver 42 to form the metering passage 58 from a portion of the metering groove 44. The metering groove 44 includes a groove axis 60 that extends the length of the metering groove 44 and cross-sectional areas 62 oriented perpendicular to the groove axis 60 that differ according to their location along the axis 60. Because the amount of fluid that flows through the receiver 42 depends on the cross-sectional area of the metering passage 58, the smallest cross-sectional area of the portion of the metering groove 44 that forms the metering passage 58 determines the amount of fluid that flows through the receiver 42. To adjust the amount of fluid that flows through the receiver 42, one increases or decreases the smallest cross-sectional area of the metering passage 58 by increasing or decreasing the portion of the metering groove 44 used to form the metering passage 58.

For example, in one embodiment, the receiver 42 may include a hole 64 that is defined by a wall 66 and that is cylindrical or substantially cylindrical, and the stem 46 may include a tip 48 that includes the metering groove 44 and that is sized and shaped to form a seal with the wall 66 when the tip 48 is positioned in the hole 64. The metering groove 44 may extend away from a distal end 68 of the tip 48. Furthermore, the metering groove 44 may be “U” shaped, and the distance between the crest and root of the “U” may decrease as the metering groove 44 extends away from the distal end 68. By decreasing the distance between the crest and root of the “U”, the cross-sectional areas 62 of the metering groove 44 decrease as the metering groove 44 extends away from the distal end 68. In this configuration, the smallest cross-sectional area of the metering passage 58 that is formed from a portion of the metering groove 44 exists at the entrance to the metering passage 58, which is located at the entrance 70 to the receiver 42. Thus, as one inserts the tip 48 further into the receiver 42, the smallest cross-sectional area of the metering passage 58 decreases and the amount of fluid that flows through the receiver 42 decreases. And, as shown in FIG. 4, as one moves the tip 48 out of the receiver 42, the smallest cross-sectional area of the metering passage 58 increases and the amount of fluid that flows through the receiver 42 increases.

Still referring to FIGS. 3 and 4, in one embodiment, one closes the valve 32 by positioning the tip 48 in the hole 66 of the receiver 42 so that all of the metering groove 44 is in the hole 66. Thus, a metering passage that permits fluid to flow through the receiver 42 is not formed. In other embodiments, the valve may be closed by a different portion of the stem 42, such as a shoulder (not shown) contacting a seat (not shown) to stop fluid from flowing to the receiver 42. By having the shoulder contact the seat when the tip 48 is positioned in the hole 66 to form a metering passage 58, one may establish an initial open position that allows an amount of fluid to flow through the receiver 42 that is greater than an initial trickle. For example, the initial open position may allow 5 grams of fluid to flow instead of 1 gram or less.

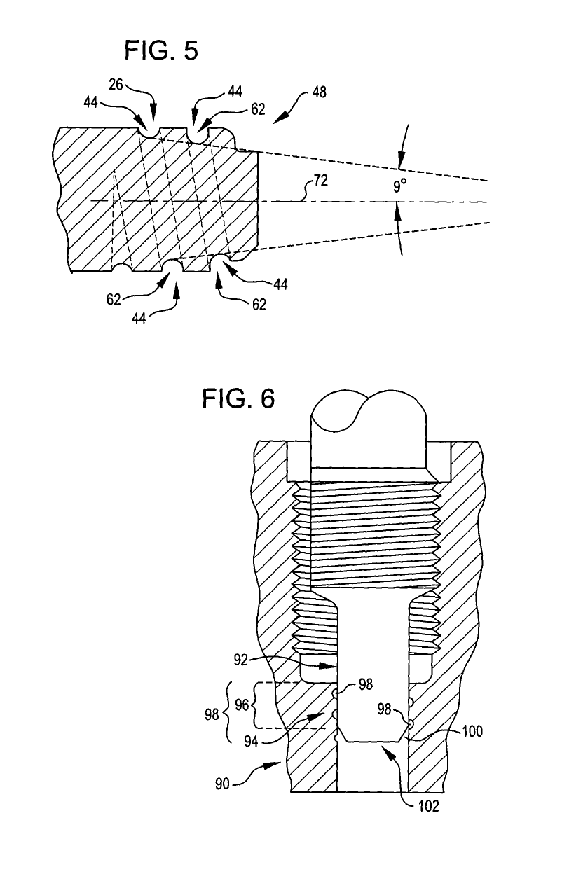

Other embodiments are contemplated. For example, the wall 66 of the receiver 42 may include the metering groove 44 (discussed in conjunction with FIG. 6). In such an embodiment, the cross-sectional areas of the groove 44 may decrease as the groove 44 extends away from the entrance 70 of the receiver 42. In another example, both the stem and the receiver may include a metering groove. In addition, the valve 32 may include more than one metering groove that may extend the same or different lengths away from the distal end 68 of the stem 46. Furthermore, the metering groove may be in the form of other shapes, for example, the metering groove may be “V” shaped. Also, the hole 64 and the tip 48 may be in the form of shapes other than cylinders, for example, the hole 64 and the tip 48 may be square or oval.

Still referring to FIGS. 3 and 4, the metering groove 44 may extend along the tip 48 in any desired direction, and the stem 46 may be coupled with the receiver 42 using any desired fastening technique that allows the tip 48 to be positioned, as desired, within the receiver 42. For example, in one embodiment, the metering groove 44 may spiral about a stem axis 72 to form a helix on the tip 48. The stem 46 may include threads 74 that correspond with threads 76 to couple the stem 46 with the receiver 42. The pitch of the helix formed by the metering groove 44 may or preferably may not match the pitch of the threads 74 and 76. If the pitch of the helix does not match the pitch of the threads 74 and 76, the portion of the tip 48 that forms the seal with the wall 66 translates against the wall 66 when the tip 48 is moved inside the receiver 42. This may be desirable to maintain the design of each cross-sectional area of the metering passage 58 after positioning the tip 48 in the receiver 42 many times. If the pitch of the helix does match the pitch of the threads 74 and 76, the portion of the wall 66 opposite the metering groove 44 would rarely, if at all, contact the tip 48. Thus, over time the wall 66 may creep into the metering groove 44 and decrease the cross-sectional area of the metering passage 58 relative to the designed cross-section area.

Other embodiments are contemplated. For example, the metering groove 44 may be straight or substantially straight as the metering groove 44 extends away from the distal end 68 of the stem 46. Or, the metering groove 44 may curve about the axis 72 and have a pitch that increases or decreases as the metering groove 44 extends away from the distal end 68.

Still referring to FIGS. 3 and 4, the receiver 42 and stem 46 may be made of any desirable material that does not chemically react with the fluid that flows through the valve 32 and/or that can physically withstand the flow of fluid through the valve 32. For example, the stem 46 may be made of any conventional brass, and the receiver 42 may be made of glass fiber reinforced polyterephthalate thermoplastic manufactured by Ticona under the federally registered trademark Celanex®.

FIG. 5 is a cross-sectional view of the tip 48 in FIGS. 3 and 4 that includes the metering groove 44 according to an embodiment of the invention. The sensitivity, i.e., the degree of fineness, in the adjustment of the amount of fluid that flows through the valve 32 (FIGS. 2-4) depends on the rate that the cross-sectional areas 62 change relative to the stem axis 72. As the rate that the cross-sectional areas 62 change decreases, the sensitivity in the adjustment of the amount of fluid that flows through the valve 32 increases. And, as the rate that the cross-sectional areas 62 change increases, the sensitivity in the adjustment of the amount of fluid that flows through the valve 32 decreases. The rate that the cross-sectional areas 62 change relative to the stem axis 72 depends on the direction the metering groove 44 extends relative to the stem axis 72, the pitch of the threads 74 and 76 (FIGS. 3 and 4), and the rate that the cross-sectional areas 62 change relative to the groove axis 60. Thus, the sensitivity in the adjustment of the amount of fluid that flows through the valve 32 may be designed to be any desired sensitivity.

For example, in one embodiment, the stem 48 may include a helical metering groove 44 having a pitch of 0.042 inches, and the threads 74 and 76 may have a pitch of 0.031 inches. The cross-sectional areas 62 of the metering groove may change at a constant or substantially constant rate of 0.0017 square inches per inch along the groove axis 60. Thus, with a helical pitch of 0.042 inches, the cross-sectional areas 62 of the metering groove 44 may change at a constant or substantially constant rate of 0.0048 square inches per inch along the stem axis 72. To increase the sensitivity, one may reduce the pitch of the helical metering groove 44, reduce the rate at which the cross-sectional areas change and/or reduce the pitch of the threads 74 and 76.

Other embodiments are contemplated. For example, the distance between the crest and root of the “U” may decrease and increase as the groove 44 extends toward the body of the stem.

FIG. 6 is a cross-sectional view of a portion of a valve 90 according to another embodiment of the invention. Similar to the valve 32 in FIGS. 2-4, one may finely adjust the amount of fluid that flows through the valve 90 by positioning a stem 92 relative to a receiver 94 to form a metering passage 96 from a metering groove 98. Unlike the valve 32, however, the receiver 94 includes the metering groove 98. Thus, the smallest cross-sectional area of the metering passage 96 that is formed from a portion of the metering groove 98 exists at the exit 100 to the metering passage 96. As one moves the tip 102 out of the receiver 94, the smallest cross-sectional area of the metering passage 96 increases and the amount of fluid that flows through the receiver 94 increases. And, as one inserts the tip 102 further into the receiver 94, the smallest cross-sectional area of the metering passage 96 decreases and the amount of fluid that flows through the receiver 42 decreases.

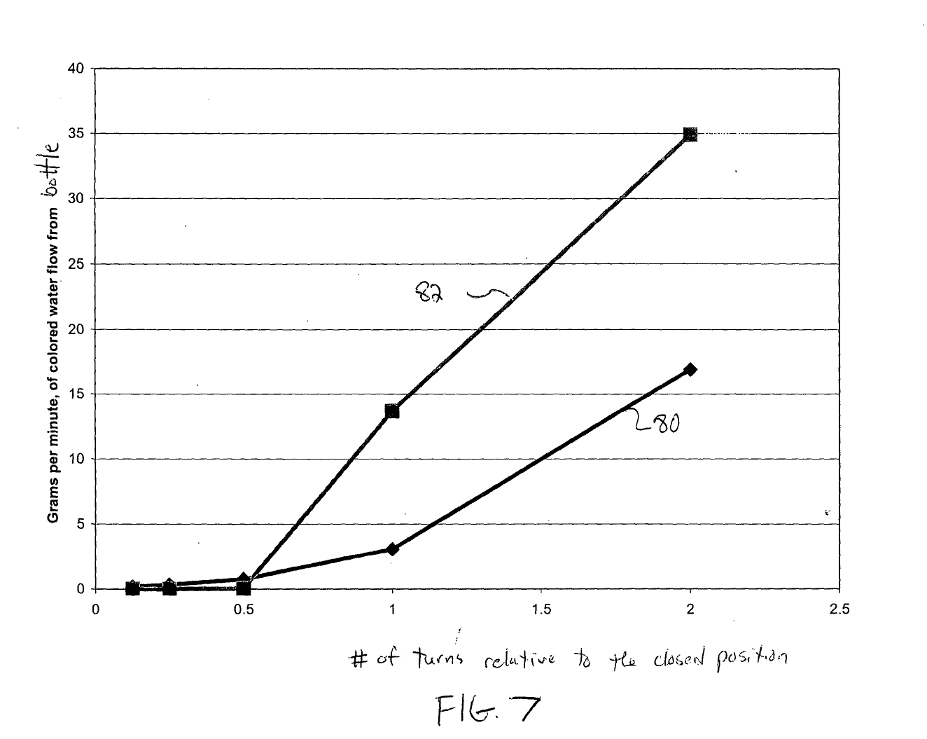

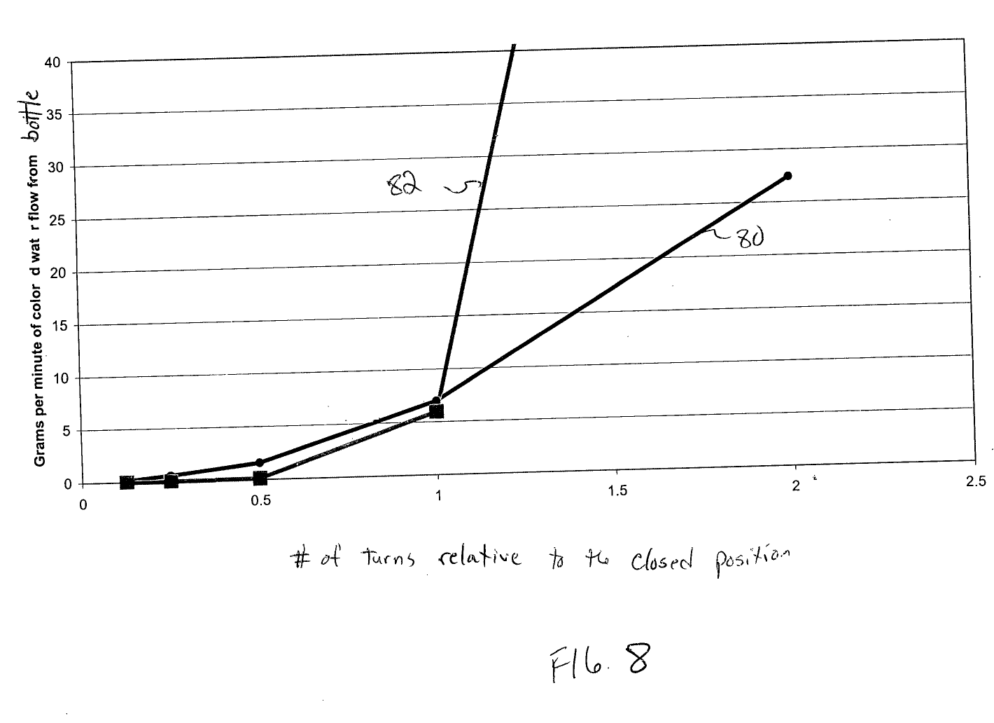

FIGS. 7 and 8 are graphs showing the difference between the sensitivity in the adjustment of the amount of fluid that flows through a conventional needle valve and the valve in FIGS. 2-5. The graph in FIG. 7 shows the difference between the sensitivities when each valve's inlet pressure is approximately 10 psi, while the graph in FIG. 8 shows the difference between the sensitivities when each valve's inlet pressure is approximately 20 psi.

Referring to FIGS. 7 and 8, the line 80 represents the amount of water flowing through the valve 32 relative to the position of the stem 46 in the receiver 42. The line 82 represents the amount of water flowing through a conventional needle valve relative to the needle's position in the valve that is sized similar to the valve 32. The amount of water is identified as grams per minute. The positions of the stem 46 and needle is identified as the number of turns made relative to the position of the stem 46 when the valve 32 is closed and the position of the needle when the needle valve is closed. As show in the graphs in FIGS. 7 and 8, the adjustment in the amount of fluid that flows through the valve 32 (FIGS. 2-4) is finer, i.e. more sensitive, than the adjustment in the amount of fluid that flows through a conventional needle valve.

Referring to FIG. 7, turning the stem 46 through half of one revolution provides an increase in the amount of water that flows through the valve 32 from 0.0 to 0.76 grams per minute; but turning the needle through half of one revolution provides only a slight increase in the amount of water that flows through the needle valve from 0.0 to 0.05 grams per minute. Furthermore, continuing to turn the stem 46 through two revolutions provides an increase in the amount of water that flows through the valve 32 from 0.76 to 16.93 grams per minute; but continuing to turn the needle through two revolutions provides a sharp increase in the amount of water that flows through the needle valve from 0.05 to 34.89. Thus, the valve 32 provides a smaller and more consistent increase in the amount of water that flows through the valve 32 as one turns the stem 46 through two revolutions than the needle valve does as one turns the needle through the same number of revolutions.

Referring to FIG. 8, the differences between the valve 32 and the needle valve are similar to the differences between the valve 32 and the needle valve discussed in conjunction with FIG. 7, except the rate of change in the amount of water that flows through the needle valve significantly increases as one turns the needle from one through two revolutions. The rate of change in the amount of water that flows through the valve 32 also increases as one turns the stem 46 from one through two revolutions, but the rate of change is much slower than the rate of change for the needle valve.

What is claimed is:

1. A valve comprising:
a receiver through which fluid flows when the valve is open;
a metering groove operable to form a metering passage and having a groove axis that extends the length of the metering groove and cross-sectional areas oriented perpendicular to the groove axis that differ according to their location along the axis, wherein the metering passage is operable to limit the flow of fluid through the receiver; and
a stem positionable relative to the receiver to form the metering passage from different portions of the metering groove to adjust the amount of fluid that may flow through the receiver.

2. The valve of claim 1 wherein the valve includes one metering groove.

3. The valve of claim 1 wherein the stem includes the metering groove.

4. The valve of claim 1 wherein the receiver includes the metering groove.

5. The valve of claim 1 wherein the stem includes a stem axis and the stem is movable in a direction along the stem axis to position the stem relative to the receiver.

6. The valve of claim 5 wherein the stem is also rotatable about the stem axis to position the stem relative to the receiver.

7. The valve of claim 6 wherein the metering groove is helical and has a groove pitch that is not equivalent to the distance the stem travels in the direction along the stem axis after completing one rotation about the stem axis.

8. The valve of claim 1 wherein:
the receiver includes a wall defining a hole,
the stem includes a tip that has the metering groove, and
the wall and metering groove form the metering passage when the tip is positioned in the hole, wherein a substantial portion of the fluid that flows through the receiver flows through the metering passage.

9. The valve of claim 8 wherein the hole and the tip are cylindrical.

10. A valve stem positionable relative to a receiver of a valve to adjust the amount of fluid that may flow through the receiver, the valve stem comprising:
a tip including a metering groove having a groove axis that extends the length of the metering groove and cross-sectional areas oriented perpendicular to the groove axis that differ according to their location along the groove axis, wherein the metering groove is operable to form a metering passage that limits the amount of fluid that may flow through the receiver.

11. The valve stem of claim 10 wherein the tip includes one metering groove.

12. The valve stem of claim 10 wherein the tip includes a distal end and the metering groove extends away from the distal end.

13. The valve stem of claim 10 wherein:
the tip includes a distal end,
the metering groove extends away from the distal end, and
the cross-sectional areas decrease as the metering groove extends away from the distal end.

14. The valve stem of claim 10 wherein:
the tip includes a distal end,
the metering groove extends away from the distal end, and
the cross-sectional areas decrease at a constant or substantially constant rate as the metering groove extends away from the distal end.

15. The valve stem of claim 10 wherein the metering groove and groove axis are helical.

16. The valve stem of claim 10 wherein the cross-sectional areas of the metering groove are “U” shaped.

17. The valve stem of claim 16 wherein each “U” shaped cross-sectional area has a crest and a root, and the cross-sectional areas differ in the distance between the crest and the root of each “U” shaped cross-sectional area.

18. The valve stem of claim 10 wherein the cross-sectional areas of the metering groove are “V” shaped.

19. The valve stem of claim 10 further comprising threads having a thread pitch and operable to position the valve stem relative to the receiver, and wherein the metering groove is helical and has a groove pitch that is not equivalent to the thread pitch.

20. The valve stem of claim 10 wherein the tip is substantially cylindrical.

21. A method for adjusting an amount of fluid flowing through a valve, the method comprising:
forming a metering passage with a metering groove having a groove axis that extends the length of the metering groove and cross-sectional areas oriented perpendicular to the groove axis that differ according to their location along the groove axis; and
positioning a valve stem relative to a receiver to establish with a cross-sectional area of the metering groove a minimum cross-sectional area of the metering passage that provides a desired amount of fluid flowing through the valve.

22. The method of claim 21 wherein forming the metering passage includes inserting a tip of the valve stem into the receiver.

23. The method of claim 21 wherein positioning the valve stem relative to the receiver includes moving the tip of the valve stem relative to the receiver in a direction along a stem axis.

24. The method of claim 23 wherein moving the valve stem relative to the receiver includes rotating the tip of the valve stem about the stem axis.

25. The method of claim 21 wherein positioning the valve stem relative to the receiver includes establishing the minimum cross-sectional area of the metering passage where the fluid enters the metering passage.

26. The method of claim 21 further comprising positioning the valve stem relative to the receiver to establish with a different cross-sectional area of the metering groove a different minimum cross-sectional area of the metering passage.
